(19) United States
(12) Patent Application Publication
(10) Pub. No.: US 2010/0123758 A1
(43) Pub. Date: May 20, 2010

(54) MICRO-FLUID EJECTION DEVICE WITH ON-CHIP SELF-MANAGED THERMAL CONTROL SYSTEM

(76) Inventors: Steven Wayne Bergstedt, Winchester, KY (US); John Glenn Edelen, Versailles, KY (US); George Keith Parish, Winchester, KY (US); Kristi Maggard Rowe, Richmond, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/270,959

(22) Filed: Nov. 14, 2008

(51) Int. Cl. B41J 2/05

(52) U.S. Cl. 347/61

(57) ABSTRACT

A micro-fluid ejection device, such as an inkjet printhead, includes a substrate, a heater chip on the substrate, a structure on the substrate for supplying ink to the heater chip and a nozzle plate on the heater chip. The heater chip has a plurality of electrically-activatable spaced apart heater elements that can be repetitively subjected to momentary electrical activation and deactivation so as to cause cyclical heating and cooling of ink in the heater chip resulting in repetitive ejection of drops of ink by the nozzle plate on the heater chip. The device also includes a thermal control system in the heater chip being self-managed by operation of a control loop defined by the thermal control system internally of the heater chip and substrate for sensing and limiting the variation of the temperature of the substrate during cyclical operation of the heater elements of the heater chip.

### CROSS REFERENCES TO RELATED APPLICATIONS

This patent application is related to the following copending U.S. patent applications assigned to the assignee of the present invention: (1) Ser. No. 11/427,174, filed Jun. 28, 2006, entitled “Actuator Chip For Inkjet Printhead With Temperature Sense Resistors Having Current Single-Point Output”; (2) Ser. No. 11/517,931, filed Sep. 8, 2006, entitled “Actuator Chip For Micro-Fluid Ejection Device With Temperature Sensing And Control Per Chip Zone”; and (3) Ser. No. 11/834,177, filed Aug. 6, 2007, entitled “Inkjet Printheads With Warming Circuits”. The disclosures of these applications are hereby incorporated herein by reference.

### BACKGROUND

1. Field of the Invention

The present invention relates generally to a micro-fluid ejection devices, such as an inkjet printhead, and, more particularly, to a micro-fluid ejection device with an on-chip thermal control system.

2. Description of the Related Art

The art of printing images with inkjet technology is well known. In general, an image is produced by jetting ink drops from a printhead at precise moments so they impact a print medium at a desired location. The quality and consistency of the printing, however, is dependent on a number of factors, one such factor being ink temperature.

Print quality and ink jetting reliability of an inkjet printhead are dependent on the temperature of an inkjet integrated circuit in the form of an electronic heater or actuator chip of the inkjet printhead. In a thermal inkjet printhead actuator chip, ink drops are ejected by heating ink at intense heat for very short duration to form a bubble that is ejected onto a target medium. The heat is generated from electrical activation and deactivation of spaced apart heater elements of the actuator chip, which is formed by layers or films of semi-conductor and other materials typically deposited on a substrate of silicon or another suitable material. This process is repeated thousands of times per second for each nozzle on the printhead that overlies one of the heater elements of the actuator chip resulting in an accumulation of heat in the regions of the printhead surrounding the heater elements that raises the temperature of the ink. Variations in ink temperature affect the size, shape, and velocity of ejected drops resulting in variations of printed density that are perceivable to the eye. To alleviate this problem printhead thermal control systems have been developed.

Thus, thermal control systems are well known for inkjet printheads. However, typically, various components of prior art thermal control systems have been positioned at different locations in the printer. Some components are provided on the printhead itself while others, such as a controller and the like, are provided on the printer console and from there have to communicate with the components on the printhead via conventional communication lines.

Improvements of these thermal control systems are disclosed in the patent applications cross-referenced above. A common approach in many of these patent applications is to maintain a more consistent temperature on a printhead by employing temperature sense elements or resistors in the printhead actuator chip. However, a drawback seen in some embodiments of these improved thermal control systems is an increased processing overhead incurred on a printhead supervisor chip and a continued need to communicate with a controller located on the printer separate from the printhead. For instance, in the case of at least some embodiments of the thermal control system of the first cross-referenced patent application, a supervisor chip tracks each thermal zone's heat status and adjusts heat accordingly via communication with a controller of the inkjet printer. The delays associated with managing multiple zones can lead to larger fluctuations in control temperature.

Thus, there remains a need for innovation in thermal control systems that will overcome some or all of the above-referenced issues.

### SUMMARY OF THE INVENTION

The present invention addresses at least some of the foregoing issues by providing a self-managed printhead thermal control system on the printhead itself. Embodiments of the present invention provide an “on-chip” thermal control system on a substrate of the inkjet printhead that is compact and has a control loop that resembles that of a type of analog-to-digital converter called a delta modulator. In some embodiments, a loop filter is physically built-in as the thermal heating time constant of the substrate.

Accordingly, in an aspect of the present invention, a micro-fluid ejection device includes a substrate, an actuator chip on the substrate having a plurality of actuator elements for receiving the micro-fluid and being electrically-activatable such that the actuator elements can be repetitively subjected to electrical activation and deactivation causing cyclical heating and cooling thereof and resulting in repetitive ejection of drops of micro-fluid by the actuator elements, and a thermal control system in the actuator chip being self-managed by operation of a control loop defined by the thermal control system internally of the actuator chip and the substrate for sensing and limiting the variation of the temperature of the substrate during cyclical operation of the actuator elements of the actuator chip.

In another aspect of the present invention, an inkjet printhead includes a substrate, a heater chip on the substrate and a structure on the substrate for supplying ink to the heater chip so as to divide said heater chip into an intersecting matrix of regions and zones, the heater chip having a plurality of electrically-activatable spaced apart heater elements in said matrix of regions and zones of said heater chip that can be repetitively subjected to electrical activation and deactivation so as to cause cyclical heating and cooling of the heater elements and thereby of the ink in the heater chip resulting in repetitive ejection of drops of ink by the cyclical operation of the heater chip, and a plurality of thermal control systems in the heater chip each in a section of said matrix of regions and zones of said heater chip, each thermal control system being self-managed by operation of a control loop defined by the thermal control system internally of the heater chip and the substrate for sensing and limiting the variation of the temperature of the substrate during cyclical operation of the heater elements of the heater chip.

In another aspect of the present invention, an on-chip thermally-controlled actuator device includes a substrate, an actuator chip on the substrate for receiving a micro-fluid and being electrically-activatable such that the actuator chip can be repetitively subjected to electrical activation and deactivation causing cyclical heating and cooling thereof and resulting in repetitive ejection of drops of micro-fluid by the actuator chip, and a thermal control system in the actuator chip being self-managed by operation of a control loop defined by the thermal control system internally of the actuator chip and the substrate for sensing and limiting the variation of the temperature of the substrate during cyclical operation of the actuator chip.

### BRIEF DESCRIPTION OF THE DRAWINGS

Having thus described the invention in general terms, reference will now be made to the accompanying drawings, which are not necessarily drawn to scale, and wherein:

FIG. 1 is a perspective view of an inkjet printhead to which can be applied an on-chip self-managed thermal control system of the present invention.

FIG. 2 is an enlarged plan view of a fragmentary portion of the printhead of FIG. 1 showing a portion of the heater chip and the substrate of the printhead.

FIG. 3 is a schematic diagram of an exemplary embodiment of an on-chip self-managed thermal control system of the present invention on the heater chip of the inkjet printhead.

FIG. 4 is a schematic diagram of a plurality of the on-chip self-managed thermal control systems of the present invention on different regions and zones of a heater chip of an inkjet printhead.

### DETAILED DESCRIPTION

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numerals refer to like elements throughout the views.

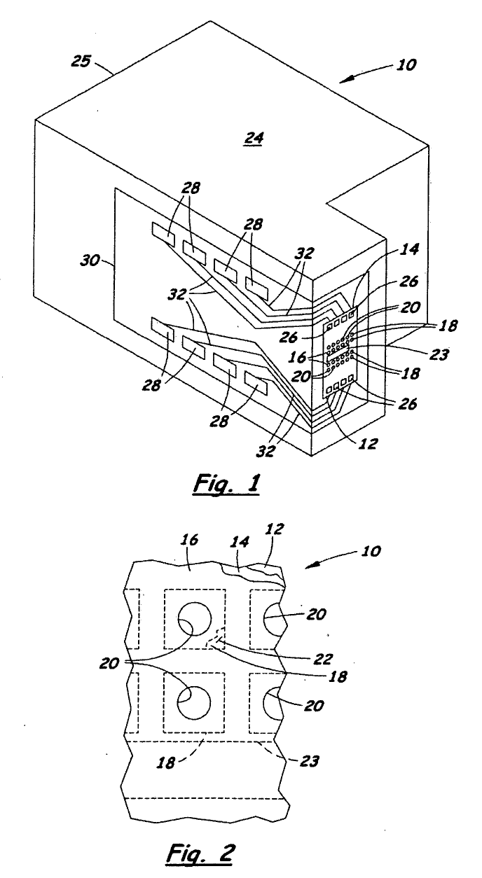

Referring now to FIGS. 1 and 2, there is illustrated a micro-fluid ejection device and, more particularly, an inkjet printhead 10. The printhead 10 includes a substrate 12, an actuator chip, such as a heater chip 14, supported on the substrate 12 in a suitable manner, and a nozzle member or plate 16 on the heater chip 14. The actuator or heater chip 14 has a plurality of spaced apart electrically-activatable actuator elements, such as heater elements 18, aligned and overlaid by nozzles 20 in the nozzle plate 16. An ink chamber 22 is defined between each heater element 18 of the heater chip 14 and each nozzle 20 of the nozzle plate 16. A structure in the form of one or more channels or vias 23 are defined in the substrate 12 and heater chip 14 for supplying ink to each ink chamber 22 in the heater chip 14 from a compartment 24 in a housing 25 of the printhead 10.

The heater elements 18 of the heater chip 14 are formed by layers or films of semi-conductor and other suitable materials typically formed or deposited, by using known micro-electronic fabrication techniques, on the substrate 12, which typically is silicon or another suitable material. The heater elements 18 of the heater chip 14 are electrically connected via input terminals 26 on the heater chip 14 and input/output (I/O) connectors 28 on a flexible circuit 30 on the printhead which are interconnected by electrical conductors 32 on the printhead 10. The I/O connectors 28 are, in turn, connected to an external device, such as a printer, fax machine, copier or the like. By such means, the heater elements 18 can be repetitively subjected to momentary electrical activation and deactivation to cause cyclical operation of the heater chip 14 to generate heating and cooling of ink in the heater chip 14. The heating and cooling of ink in the heater chip 14 results in the repetitive ejection of drops of ink from the ink chambers 22 through the nozzles 20 of the printhead 10. Exemplary embodiments of the printhead 10 as just briefly described are the ones disclosed in more detail in U.S. Pat. Nos. 6,676,246, 6,805,431 and 6,834,941 assigned to the assignee of the present invention. The disclosures of these patents are hereby incorporated herein by reference.

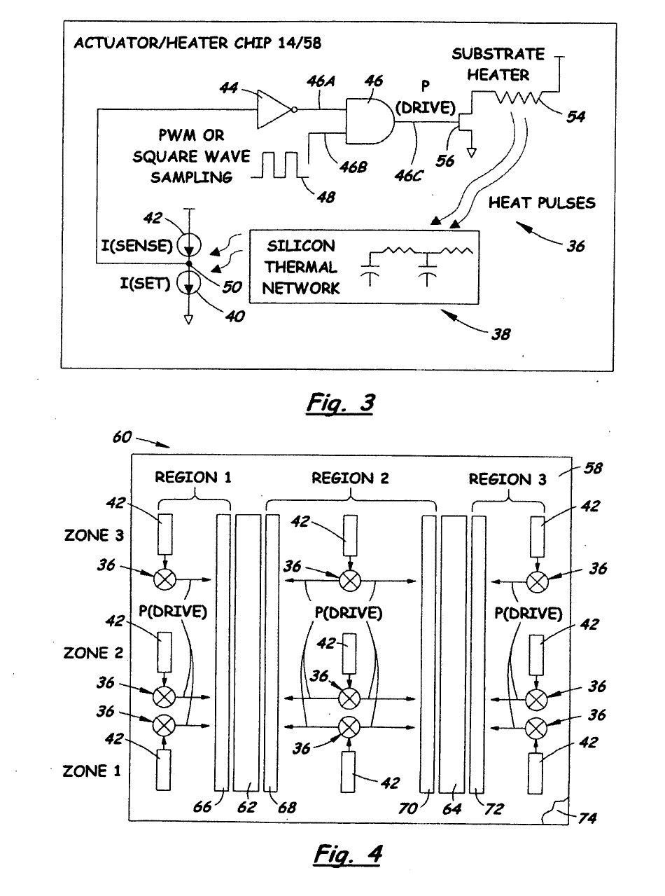

Referring now to FIG. 3, there is illustrated a compact on-chip thermal control system, generally designated 36, in the actuator or heater chip 14 of FIG. 1 in accordance with an embodiment of the present invention. The thermal control system 36 basically is self-managed by operation of a control loop defined by the thermal control system 36 internally of the actuator chip 14 and the substrate 12 for sensing and limiting the variation of the temperature of the substrate 12 during cyclical operation of the actuator chip 14. The control loop functions similar to a type of analog-to-digital converter called a delta modulator, but here has a loop filter 38 physically built-in as the thermal heating time constant of the silicon material of the substrate 12.

More particularly, the control loop includes a set point driver 40 that inputs a desired temperature set point current input I(set) to the control loop and a temperature sensor 42 that senses and inputs an actual sensor temperature current input I(sense) to the control loop. The set point driver 40 and temperature sensor 42 combine these current inputs and produce a current output I(diff) being the difference between these current inputs.

The control loop defined by the thermal control system 36 also includes a quantizer 44 in the form of an inverter that receives the current output I(diff) and inverts it before inputting it to one input of an AND gate 46. The other input of the AND gate 46 receives a sampling square wave 48. The AND gate 46 converts the two inputs into drive pulses P(drive). The AND gate 46 may be one made of six CMOS transistors. The quantizer or inverter 44 may be one made of two CMOS transistors, interconnected between a junction 50 between the output sides of the set point driver 40 and the temperature sensor 42 and the one input 46A of the AND gate 46. The sampling square wave 48 is applied from a suitable source to the other input 46B of the AND gate 46. The source of the sample rate may be a simple square wave generator. The duty cycle of the square wave generator can be modified to control the level of quantization but a fixed 50% duty cycle square wave will work as well. The frequency of the square wave is the sample rate and it is inversely proportional to the magnitude of the temperature fluctuation or ripple. A square wave with a 1 ms period has been shown to achieve a ripple of less than 1 degree Celsius.

In some embodiments, as an alternative to the use of the simple square wave generator, a pulse width modulation (PWM) generator controlling the sampling pulse width of the quantizer 44 is used to make modifications/improvements to the basic control system. In fact, the square wave 48 duty cycle may be used as another input in the algorithm of the control system 36. For example, the quantizer 44 could have a large duty cycle during the initial thermal ramp up to the set point temperature, to allow a smaller delay before the first page begins to print. After the initial thermal ramp the duty cycle could be proportional to the difference between the set point temperature and the current chip temperature. The resulting pulse width control would make the thermal system response faster and more accurate for a small additional circuit to generate pulse width values.

The control loop defined by the thermal control system 36 further includes a substrate heater resistor 54 in or above the substrate 12 and a switch 56, such as a NMOS switch, interconnected between an output 46C of the AND gate 46 and the substrate heater resistor 54. The switch 56 receives the drive pulses P(drive) from the output 46C of the AND gate 46 and in response thereto periodically activates the substrate heater resistor 54 to produce heat pulses P(heat) that are delivered to the substrate 12 and averaged as the heat propagates through the substrate 12. The heat pulses P(heat) travel throughout the silicon substrate 12 which spreads out the heat and acts equivalently to the loop filter 38 which averages the pulses to an average temperature. The temperature sensor 42, receives the average temperature and converts it to a current that is proportional with increasing temperature. The control loop servos until the current at the temperature sensor 42 is equal to the desired set current of the set point driver 40 which corresponds to the required temperature.

FIG. 4 shows an exemplary embodiment of a heater chip 58 of an inkjet printhead 60 having a pair of vias 62 and 64 each formed between a pair of columns of nozzle and heater units 66, 68 and 70, 72. The vias 62, 64 are formed in the substrate 74 which underlies the heater chip 58 and also extend into portions of the heater chip 58. Thus, the vias 62, 64 may interrupt the travel of heat pulses throughout the silicon substrate 74 should only a single thermal control system 36 be provided for the entire heater chip 58. Since the thermal control system 36 is an on-chip, control loop, self-managed unit, a plurality of such systems 36 can be readily provided on the heater chip 58 so as to provide coverage of an intersecting matrix of regions 1-3, running along an X-axis, and zones 1-3, running along a Y-axis, as illustrated in FIG. 4.

The foregoing description of one or several embodiments of the invention has been presented for purposes of illustration. It is not intended to be exhaustive or to limit the invention to the precise forms disclosed, and obviously many modifications and variations are possible in light of the above teaching. It is intended that the scope of the invention be defined by the claims appended hereto.

What is claimed is:

1. A micro-fluid ejection device, comprising:
a substrate;
an actuator chip on said substrate having plurality of actuator elements for receiving a micro-fluid and being electrically-activatable such that said actuator elements can be repetitively subjected to electrical activation and deactivation causing cyclical heating and cooling thereof and resulting in repetitive ejection of drops of micro-fluid by said actuator elements; and
a thermal control system in said actuator chip being self-managed by operation of a control loop defined by said thermal control system internally of said actuator chip and said substrate for sensing and limiting the variation of the temperature of said substrate during cyclical operation of said actuator elements.

2. The device of claim 1 wherein said control loop of said thermal control system functions as a type of delta modulator having a loop filter physically built-in as the thermal heating time constant of said predetermined material of said substrate.

3. The device of claim 2 wherein said substrate is a silicon substrate.

4. The device of claim 1 wherein said control loop includes:
a set point driver for inputting a desired temperature set point current input; and
a temperature sensor for sensing and inputting an actual sensor temperature current input, said set point driver and said temperature sensor also for combining said current inputs and producing a current output being a difference between said current inputs.

5. The device of claim 4 wherein said thermal control system also includes:
a quantizer for receiving said current output and one of square wave pulses or pulse width modulated pulses and sampling said current output therewith and converting said sampled output into drive pulses;
a substrate heater resistor in or about said substrate; and
a switch connected to said substrate heater resistor for receiving said drive pulses and in response thereto periodically activating said substrate heater resistor for producing heat pulses that are delivered to said substrate and averaged as the heat propagates through said substrate.

6. The device of claim 5 wherein said thermal heating time constant of said substrate material is interpreted by said temperature sensor as a loop filter which averages said heat pulses and servos to drive said temperature sensor current input to equal said set point driver current input.

7. An inkjet printhead, comprising:
a substrate;
a heater chip on said substrate;
a structure on said substrate for supplying ink to said heater chip so as to divide said heater chip into an intersecting matrix of regions and zones;
said heater chip having a plurality of electrically-activatable spaced apart heater elements in said matrix of regions and zones of said heater chip that can be repetitively subjected to electrical activation and deactivation so as to cause cyclical heating and cooling of said heater elements and thereby of ink in said heater chip resulting in repetitive ejection of drops of ink by said cyclical operation of said heater chip; and
a plurality of thermal control systems in said heater chip each in a section of said matrix of regions and zones of said heater chip, each thermal control system being self-managed by operation of a control loop defined by said thermal control system internally of said heater chip and said substrate for sensing and limiting the variation of the temperature of said substrate during cyclical operation of the heater elements of said heater chip.

8. The printhead of claim 7 wherein said control loop of each of said thermal control systems functions as a type of delta modulator having a loop filter physically built-in as the thermal heating time constant of said predetermined material of said substrate.

9. The printhead of claim 8 wherein said substrate is composed at least substantially from silicon.

10. The printhead of claim 7 wherein said control loop includes:
a set point driver for inputting a desired temperature set point current input; and
a temperature sensor for sensing and inputting an actual sensor temperature current input, said set point driver and said temperature sensor also for combining said current inputs and producing a current output being the difference between said current inputs.

11. The printhead of claim 10 wherein said thermal control system also includes:
a quantizer for receiving and sampling said current output and converting said sampled output into drive pulses;
a substrate heater resistor above or in said substrate; and
a switch connected to said substrate heater resistor for receiving said drive pulses and in response thereto periodically activating said substrate heater resistor for producing heat pulses that are delivered to said substrate and averaged as the heat propagates through said substrate.

12. The printhead of claim 11 wherein said thermal heating time constant of said substrate material is interpreted by said dynamic sensor as a loop filter which averages said heat pulses and servos to drive said dynamic sensor current input to equal said static sensor current input.

13. An on-chip thermally-controlled actuator device, comprising:
a substrate;
an actuator chip on said substrate for receiving a micro-fluid and being electrically-activatable such that said actuator chip can be repetitively subjected to electrical activation and deactivation causing cyclical heating and cooling thereof and resulting in repetitive ejection of drops of micro-fluid by said actuator chip; and
a thermal control system in said actuator chip being self-managed by operation of a control loop defined by said thermal control system internally of said actuator chip and said substrate for sensing and limiting variation of a temperature of said substrate during cyclical operation of said actuator chip.

14. The device of claim 13 wherein said control loop of said thermal control system functions as a type of delta modulator having a loop filter physically built-in as the thermal heating time constant of said predetermined material of said substrate.

15. The device of claim 14 wherein said substrate is composed at least partially from silicon.

16. The device of claim 13 wherein said control loop includes:
a set point driver for inputting a desired temperature set point current input; and
a temperature sensor for sensing and inputting an actual sensor temperature current input, said set point driver and said temperature sensor also for combining said current inputs and producing a current output being a difference between said current inputs.

17. The device of claim 16 wherein said thermal control system also includes:
a quantizer for receiving said current output and one of square wave pulses or pulse width modulated pulses and sampling said current output and converting said sampled output into drive pulses;
a substrate heater resistor in or about said substrate; and
a switch connected to said substrate heater resistor for receiving said drive pulses and in response thereto periodically activating said substrate heater resistor for producing heat pulses that are delivered to said substrate and averaged as the heat propagates through said substrate.

18. The device of claim 17 wherein said quantizer includes an AND gate, a CMOS inverter connected to one input of said AND gate and said sampling square wave or pulse width modulated pulses applied to the other input of said AND gate.

19. The device of claim 18 wherein said switch is a NMOS switch.

20. The device of claim 17 wherein said thermal heating time constant of said substrate material is interpreted by said temperature sensor as a loop filter which averages said heat pulses and servos to drive said temperature sensor current input to equal said set point driver current input.
